(19) United States
(12) Patent Application Publication
(10) Pub. No.: US 2004/0240079 A1
(43) Pub. Date: Dec. 2, 2004

(54) Optical system, exposure apparatus having the optical system and device producing method

(75) Inventor: Jin Nishikawa, Kumagaya-Shi (JP)

Correspondence Address: OLIFF & BERRIDGE, PLC, P.O. BOX 19928, ALEXANDRIA, VA, 22320, US

(73) Assignee: NIKON CORPORATION, Chiyoda-ku (JP)

(21) Appl. No.: 10/792,887

(22) Filed: Mar. 5, 2004

Related U.S. Application Data
(63) Continuation of application No. PCT/JP02/08543, filed on Aug. 23, 2002.

(30) Foreign Application Priority Data
Sep. 7, 2001 (JP) 2001-271387

(51) Int. Cl. G03B 27/42; G02B 9/00

(52) U.S. Cl. 359/754

(57) ABSTRACT

An optical system comprises an optical member which is made of a crystal belonging to a cubic system and which is disposed along an optical axis which forms a predetermined angle between the optical axis and a direction of gravity, wherein the optical member is disposed such that a crystal axis [100] (or a crystal axis which is equivalent to the crystal axis [100]) of the crystal substantially coincides with the optical axis.

### This application is a continuation of PCT/JP02/08543 filed Aug. 23, 2002, the entire contents of which are incorporated by reference.

### BACKGROUND OF THE INVENTION

1. Field of the Invention

The present invention relates to an optical system and an exposure apparatus having the optical system., and more particularly, to a projection optical system and an illumination optical system suitable for an exposure apparatus used when a micro device such as a semiconductor device and a liquid crystal display device produced in a photolithography process.

2. Description of the Related Art

A photolithography process for producing a semiconductor device and the like uses an exposure apparatus which exposes, through a projection optical system, a pattern image of a photomask or a reticle (generally called “mask”, hereinafter) on a wafer (or a glass plate or the like) on which a photoresist or the like is applied. As an integration degree of a semiconductor device or the like is increased, a resolving power (resolution) required for the projection optical system of the exposure apparatus is increased. As a result, to satisfy the required resolving power of the projection optical system, it is necessary to shorten the wavelength of illumination light (exposure light) and to increase numerical apertures (NA) of the projection optical system.

However, if the wavelength of the illumination light is shortened, adsorption of light is strikingly increased, and selection of practical glass materials (optical materials) is limited. Especially when the wavelength of the Illumination light becomes 180 nm or shorter, practically usable glass material is limited to calcium fluoride crystal (fluorite) only. As a result, in the refractive projection optical system, it becomes impossible to correct the chromatic aberration. Here, the refractive optical system is an optical system which includes only radiation transmissive optical member and does not include a reflecting mirror (concave reflecting mirror or convex reflecting mirror) having power.

As described above, in the refractive type projection optical system comprising a single glass material, the permissible chromatic aberration is limited, and it becomes absolutely necessary to reduce the band of a laser light source to an extremely narrow value. In this case, the cost of the laser light source is increased and output thereof is reduced. In the refractive optical system, it is necessary to dispose a large number of positive lenses and negative lenses in order to bring a Petzval sum which determines an amount of curvature of field close to 0. In this regard, the concave reflecting mirror corresponds to a positive lens as an optical device which converges light, but is different from the positive lens in that the chromatic aberration is not generated and a value of its Petzval sum is negative (a value of Petzval sum of the positive lens is positive).

In the case of a so-called catadioptrical optical system comprising a combination of a concave reflectlng mirror and a lens, the utilization of the above-described characteristics of the concave reflecting mirror is maximized in the optical design, and it is possible to excellently correct the chromatic aberration including the curvature of field although its configuration is simple. Thereupon, in the case of an exposure apparatus using exposure light having wavelength of 180 nm or less, it is proposed to constitute the projection optical system as a catadioptrical optical system.

However, the conventional catadioptrical type projection optical system does not take, into account, a relative relation between a direction of gravity and a crystal axis of a fluorite optical member (typically, fluorite lens) disposed along an optical axis (typically, optical system extending in the horizontal direction) which does not coincide with the direction of gravity. As a result, it can be considered a configuration in which a crystal axis [111] and a horizontal optical axis of a fluorite lens disposed along a horizontal optical axis extending in the horizontal direction are brought into coincidence with each other, and its crystal axis [100] (or crystal axis [010] or crystal axis [001]) is disposed upward in the direction of gravity. According to this configuration, however, there is a problem that wavefront aberration, especially astigmatism is less prone to be generated and the wavefront aberration is prone to be deteriorated due to fine deformation of the optical surface of the fluorite lens generated by the influence of the gravity.

### SUMMARY OF THE INVENTION

The present invention has been accomplished in view of the above problem, and it is an object of the invention to provided an optical system and an exposure apparatus having the optical system having excellent optical performance and capable of suppressing deterioration in wavefront aberration caused by fine deformation of an optical surface of a fluorite optical member disposed along an optical axis which forms a predetermined angle between the optical axis and a direction of gravity.

To solve the above problem, a first invention according to the present invention provides an optical system characterized by comprising an optical member which is made of a crystal belonging to a cubic system and which is disposed along an optical axis which forms a predetermined angle between the optical axis and a direction of gravity, wherein

the optical member is disposed such that a crystal axis [100] (or a crystal axis which is equivalent to the crystal axis [100]) of the crystal substantially coincides with the optical axis.

According to a preferred aspect of the first invention, a crystal axis [010] (or a crystal axis which is equivalent to the crystal axis [010]) of the crystal is disposed along a plane including the direction of gravity and the optical axis or along a plane in the vicinity of the plane.

A second invention according to the present invention provides an optical system comprising an optical member which is made of crystal belonging to a cubic system and which is disposed along an optical axis which forms a predetermined angle between the optical axis and a direction of gravity, wherein

the optical member is disposed such that a crystal axis [110] or a crystal axis which is equivalent to the crystal axis [110]) of the crystal substantially coincides with the optical axis.

According to a preferred aspect of the second invention, a crystal axis [1-10] (or a crystal axis which is equivalent to the crystal axis [1-10]) of the crystal is disposed such that the crystal axis [1-10] forms an angle of about 90° with respect to a plane including the direction of gravity and the optical axis.

A third invention according to the present invention provides an optical system comprising an optical member which is made of a crystal belonging to a cubic system and which is disposed along an optical axis which forms a predetermined angle between the optical axis and a direction of gravity, wherein

the optical member is disposed such that a crystal axis [111] (or a crystal axis which is equivalent to the crystal axis [111]) of the crystal substantially coincides with the optical axis, and

a crystal axis [100] (or a crystal axis which is equivalent to the crystal axis [100]) of the crystal is set to form an angle which is substantially greater than 0° with respect to a plane including the direction of gravity and the optical axis.

According to a preferred aspect of the third invention, a crystal axis [100] (or a crystal axis which is equivalent to the crystal axis [100]) of the crystal forms an angle of about 60° with respect to the plane including the direction of gravity and the optical axis.

According to a preferred aspect of the first to third inventions, the optical system further comprises an optical member disposed along the optical axis in the direction of gravity, wherein the predetermined angle is in a range of 60° to 90°. Further, it is preferable that the crystal is a calcium fluoride crystal or a barium fluoride crystal.

A fourth invention according to the present invention provides an exposure apparatus, comprising:

an illumination optical system for illuminating a mask, and

the optical system according to the first to third inventions for forming an image of a pattern formed on the mask onto a photosensitive substrate.

A fifth invention according to the present invention provides an exposure apparatus, comprising:

the optical system according to the first to third inventions for illuminating a mask, and a projection optical system for forming an image of a pattern formed on the mask onto a photosensitive substrate.

### BRIEF DESCRIPTION OF THE DRAWINGS

The above and further objects, features and advantages of the present invention will become more apparent from the following detailed description taken in conjunction with the accompanying drawings, wherein:

FIG. 1 is a schematic diagram showing a configuration of an exposure apparatus having an optical system according to the embodiments of the invention;

FIG. 2 is a schematic diagram showing a configuration of the projection optical system according to the present embodiments;

FIG. 3 is a diagram for explaining names of crystal axes in a crystal of a cubic system such as fluorite;

FIG. 4 show a relation between the arrangement of crystal axes of the fluorite lens with respect to the optical axis and deformation of the optical surface of the fluorite lens;

FIG. 5 show a relation between the arrangement of crystal axes of the fluorite lens with respect to the optical axis and deformation of the optical surface of the fluorite lens;

FIG. 6 is a flowchart showing a technique for obtaining a semiconductor device as a micro device: and

FIG. 7 is a flowchart showing a technique for obtaining a liquid crystal display device as a micro device.

### DESCRIPTION OF THE PREFERRED EMBODIMENTS

An embodiment of the present invention will be explained based on the accompanying drawings.

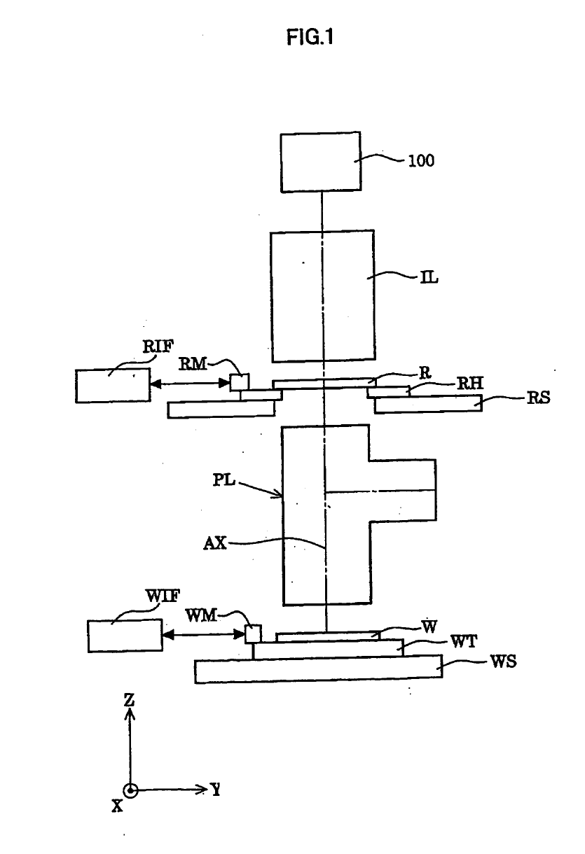

FIG. 1 is a schematic diagram showing a configuration of an exposure apparatus having an optical system according to the embodiment of the invention. In this embodiment, the present invention Is applied to a catadioptrical type projection optical system. In FIG. 1, a Z-axis is in parallel to a reference optical axis AX of the catadioptrical type projection optical system PL, a Y-axis is in parallel to a paper plane of FIG. 1 in a plane perpendicular to the optical axis AX, and an X-axis is perpendicular to the paper plane of FIG. 1 in the plane perpendicular to the optical axis AX.

The exposure apparartus includes an F₂ laser (wavelength is 157.6 nm) as a light source 100 for supplying illumination light in an ultraviolet region. Light emitted from the light source 100 uniformly illuminates a reticle (mask) R formed with a predetermined pattern through an illumination optical system IL. An optical path between the light source 100 and the illumination optical system IL is hermetically closed with a casing (not shown). Gas in a space from the light source 100 to an optical member closest to the reticle R in the illumination optical system IL is replaced by inert gas such as helium gas or nitrogen having low absorptance of exposure light, or the space Is maintained in a substantially vacuum state.

The reticle R is held on a reticle stage RS in parallel to an XY plane through a reticle holder RH. A pattern to be transferred is formed on the reticle R. A rectangular (slit-like) pattern region in the entire pattern region which has a long side extending along the X direction and a short side extending along the Y direction is illuminated with light. The reticle stage RS can move two dimensionally along a reticle plane (e.g., XY plane) by a driving system (not shown). Position coordinates of the reticle stage RS are measured by an interferometer RIF using a reticle moving mirror RM, and a position of the reticle stage RS is controlled.

Light from the pattern formed on the reticle R forms a reticle pattern image on a wafer W which is a photosensitive substrate through the catadioptrical type projection optical system PL. The wafer W is held on the wafer stage WS in parallel to the XY plane through a wafer table (wafer holder) WT. The pattern image is formed in a rectangular exposure region having a long side extending along the X direction and a short side extending along the Y direction on the wafer W such that the exposure region optically corresponds to a rectangular illumination region on the reticle R. The wafer stage WS can move two dimensionally along the wafer plane (i.e., XY plane) by the driving system (not shown). The position coordinates of the wafer stage WS is measured by an interferometer WIP using a reticle moving mirror RM, and a position of the wafer stage WS is controlled.

In the exposure apparatus, an air-tight state of an interior of the projection optical system PL is maintained between an optical member disposed closest to the reticle and an optical member disposed closest to the wafer among optical members constituting the projection optical system PL. Gas in the projection optical system PL is replaced by inert gas such as helium gas or nitrogen, or the interior is maintained in a substantially vacuum state.

The reticle R and the reticle stage RS are disposed in a narrow optical path between the illumination optical system IL and the projection optical system PL. An interior of a casing (not shown) which surrounds the reticle R and the reticle stage RS in a sealing manner is filled with inert gas such as nitrogen or helium, or the interior is maintained in a substantially vacuum state.

The wafer W and the wafer stage WS are disposed in a narrow optical path between the projection optical system PL and the wafer W. An interior of a casing (not shown) which surrounds the wafer W and the wafer stage WS in a sealing manner is filled with inert gas such as nitrogen or helium, or the interior is maintained in a substantially vacuum state. Alternatively, the narrow optical path between the projection optical system PL and the wafer W is locally purged (inert gas is allowed to always flow from a direction crossing the optical axis). An atmosphere in which exposure light is not absorbed almost at all is formed over the entire optical path from the light source 100 to the wafer W.

As described above, the illumination region on the reticle R and the exposure region on the wafer W defined by the projection optical system PL are rectangular in shape having a short side extending along the Y direction. Therefore, if the reticle stage RS and the wafer stage WS and thus the reticle R and the wafer W are moved (scanned) synchronously in the same direction along the short side direction (i.e., Y direction) of the rectangular exposure region and illumination region while controlling the positions of the reticle R and the wafer W using the driving systems and the interferometers (RIF, WIF), the reticle pattern is scanned and exposed on a region having a width equal to the long side of the exposure region on the wafer W and having a length corresponding to a scanning amount (moving amount) of the wafer W.

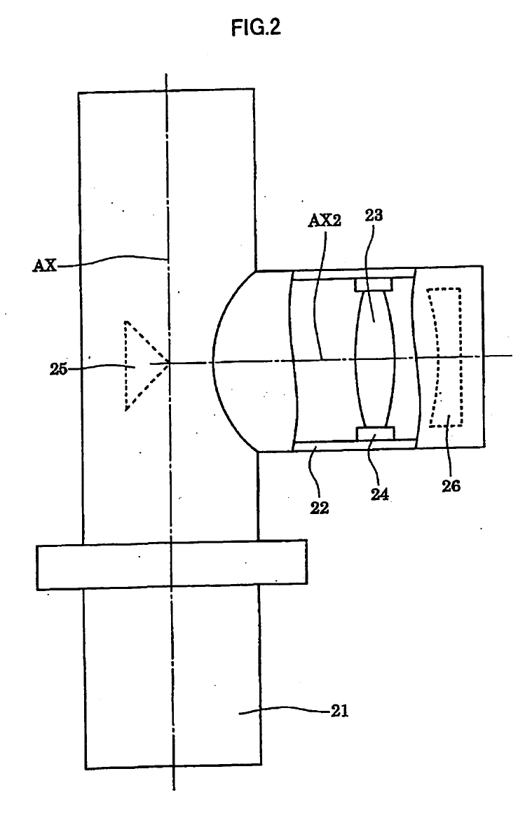

FIG. 2 is a schematic diagram showing a configuration of the projection optical system according to this embodiment. Referring to FIG. 2, the projection optical system PL comprises a vertical lens barrel 21 for holding an optical member disposed along the reference optical axis AX in the vertical direction which coincides with the direction of gravity, and a lateral lens barrel 22 for holding an optical member disposed along a second optical axis AX2 in the horizontal direction perpendicular to the reference optical axis AX.

An optical material through which ultraviolet rays having short wavelength such as F₂ laser beam excellently pass and which has excellent uniformity is limited to fluorite at present. Thus, disposed in the vertical lens barrel 21 are a plurality of fluorite lenses (lenses made of fluorite, not shown) including a rectangular prism 25 as optical path deflecting means shown with a broken line in the drawing. A fluorite lens 23 and a concave reflecting mirror 26 shown with a broken line in the drawings are disposed in the lateral lens barrel 22. The effect of the embodiment will be explained mainly based on the fluorite lens 23 mounted on the lateral lens barrel 22 through holding hardware 24.

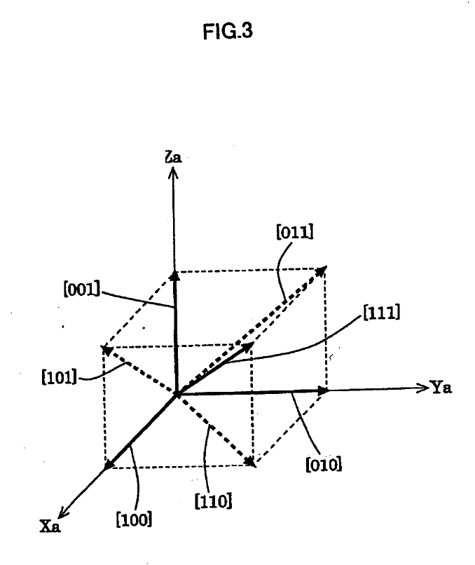

FIG. 3 is a diagram for explaining names of crystal axes in a crystal of a cubic system such as fluorite. The cubic system is a crystal structure in which cubic unit cells are cyclically arranged in directions of sides of the cube. As shown in FIG. 3, the sides of the cube intersect with each other at right angles, and the sides are called Xa-axis, Ya-axis and Za-axis. Here, a + direction of the Xa-axis is a direction of a crystal axis [100], a + direction of the Ya-axis is a direction of a crystal axis [010], and a + direction of the Za-axis is a direction of a crystal axis [001].

More generally, if orientation vector (x1, y1, z1) is selected in the above (Xa, Ya, Za) coordinate system, its orientation is In a direction of crystal axis [x1, y1, z1]. For example, the orientation of the crystal axis [111] coincides with the orientation of the orientation vector (1, 1, 1). Of course, in a crystal of the cubic system, the Xa-axis, the Ya-axis and the Za-axis are totally equivalent to each other both optically and mechanically, and these axes can not be distinguished from each other in an actual crystal. Similarly, crystal axes having different eight numbers and symbols such as the crystal axes [011], [0-11], [110] are also equivalent to each other both optically and mechanically.

In this embodiment, the crystal axis [100] of the fluorite lens 23 is disposed such that it coincides with the second optical axis AX2, and the crystal axis [010] is disposed along a plane including the reference optical axis AX and the second optical axis AX2. As a result, the astigmatism is less prone to be generated, and the wavefront aberration is less prone to be deteriorated due to a saddle-like deformation of the optical surface of the fluorite lens 23 generated by the influence of gravity based on later-described effect. That is, deterioration of the wavefront aberration caused by fine deformation of the optical surface of the fluorite lens 23 disposed along the second optical axis AX2 which forms 90° between itself and the direction of gravity is suppressed, and a projection optical system PL having excellent optical performance can be realized. The saddle-like deformation will be explained. The saddle-like deformation is deformation having a large deformation direction and a small deformation direction in a state in which the optical surface is not deformed rotation-symmetrically.

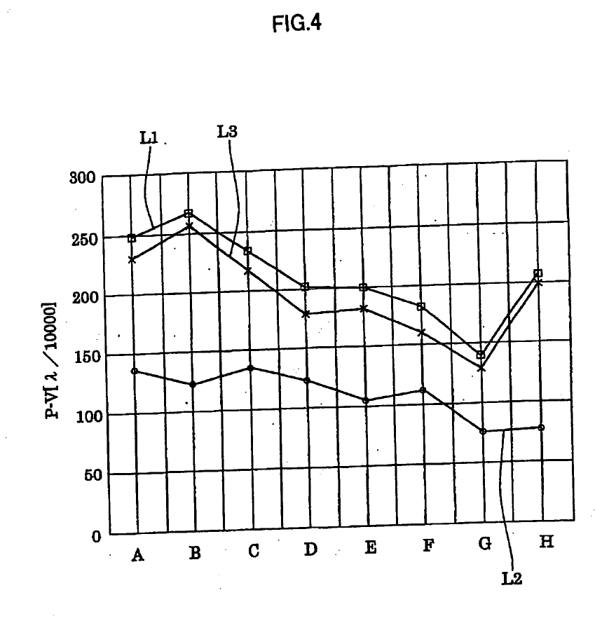

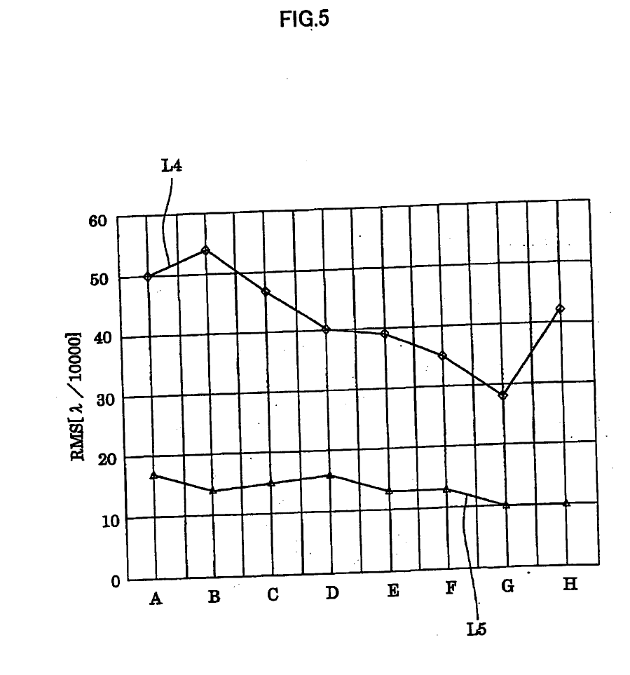

FIGS. 4 and 5 show a relation between the arrangement of crystal axes of the fluorite lens with respect to the optical axis and deformation of the optical surface of the fluorite lens. In FIGS. 4 and 5, the lateral axis shows the arrangement of the crystal axis of the fluorite lens 23 with respect to the second optical axis AX2. Here, B of the lateral axis shows a state of the conventional technique in which the crystal axis [111] of the fluorite lens 23 is disposed such that it coincides with the second optical axis AX2 and its crystal axis [100] is disposed along a plane (“reference planes”, hereinafter) including the reference optical axis AX and the second optical axis AX2.

Further, C of the lateral axis shows a state in which the crystal axis [111] of the fluorite lens 23 is disposed such that it coincides with the second optical axis AX2 and its crystal axis [100] forms 30° with respect to the reference plane. Further, D of the lateral axis shows a state in which the crystal axis [111] of the fluorite lens 23 is disposed such that it coincides with the second optical axis AX2 and its crystal axis [111] forms 60° with respect to the reference plane. A state in which the crystal axis [100] is disposed such as to form 90° with respect to the reference plane is equivalent to the state B, a state in which the crystal axis [100] is disposed such as to form 120° with respect to the reference plane is equivalent to the state C, and a state in which the crystal axis [100] is disposed such as to form 150° with respect to the reference plane is, equivalent to the state D. The angles formed by the crystal axis [100] with respect to the reference plane are angles obtained by rotating the crystal axis [100] around the crystal axis [111] from a state in which the crystal axis [111] of the fluorite lens 23 is disposed such that it coincides with the second optical axis AX2 and its crystal axis [100] is disposed along the reference plane.

Further, E of the lateral axis shows a state in which the crystal axis [110] of the fluorite lens 23 is disposed such that it coincides with the second optical axis AX2 and its crystal axis [1-10] is disposed along the reference plane. Further, F of the lateral axis shows a state in which the crystal axis [110] of the fluorite lens 23 is disposed such that it coincides with the second optical axis AX2 and its crystal axis [1-10] forms 90° with respect to the reference plane. A state in which the crystal axis [1-10] is disposed such as to form 180° with respect to the reference plane is equivalent to the state E. The angles formed by the crystal axis [1-10] with respect to the reference plane are angles obtained by rotating the crystal axis [1-10] around the crystal axis [110] from a state in which the crystal axis [110] of the fluorite lens 23 is disposed such that it coincides with the second optical axis AX2 and its crystal axis [1-10] is disposed along the reference plane.

Further, G of the lateral axis shows a state in which the crystal axis [100] of the fluorite lens 23 is disposed such that it coincides with the second optical axis AX2 and its crystal axis [010] is disposed along the reference plane. Further, H of the lateral axis shows a state in which the crystal axis [100] of the fluorite lens 23 is disposed such that it coincides with the second optical axis AX2 and its crystal axis [010] forms 45° with respect to the reference plane. A state in which the crystal axis [010] is disposed such as to form 90° with respect to the reference plane is equivalent to the state. G. A state in which the crystal axis [010] is disposed such as to form 135° with respect to the reference plane is equivalent to the state H. The angles formed by the crystal axis [010] with respect to the reference plane are angles obtained by rotating the crystal axis [010] around the crystal axis [100] from a state in which the crystal axis [100] of the fluorite lens 23 is disposed such that it coincides with the second optical:axis AX2 and its crystal axis [010] is disposed along the reference plane.

Here, A of the lateral axis shows a comparative example in which the lens is made of isotropic material having equal rigidities in all directions. In FIG. 4, the vertical axis shows a P-V value (peak to valley: difference between maximum value and minimum value) of a deformation amount caused by influence of gravity when a wavelength (633 nm) of measurement light is defined as λ. In FIG. 5, the vertical axis shows an RMS value (root mean square) of a deformation amount caused by influence of gravity when a wavelength (633 nm) of measurement light is defined as λ. The P-V value of the deformation amount is a value obtained by subtracting a deformation amount in a direction having smaller deformation from a deformation amount in a direction having larger deformation.

Referring to FIG. 4, a line L1 shows a total component (total P-V value) which is a sum total of a rotation symmetric component and a random component. A line L2 shows a random component (random P-V value) obtained by subtracting the rotation symmetric component from the total component. A line L3 shows a saddle-like deformation component which generates 2θ component (astigmatism) when the deformation amount is expressed in accordance with Zernike. Referring to FIG. 5, a line L4 shows a total component (total RMS value) which is a sum total of the rotation symmetric component and the random component. A line L5 shows a random component (random RMS value) obtained by subtracting the rotation symmetric component from the total component.

Referring to FIGS. 4 and 5, according to the state of this embodiment (state G) in which the crystal axis [100] of the fluorite lens 23 is disposed such that it coincides with the second optical axis AX2 and its crystal axis [010] is disposed along the reference plane, it can be found that the deformation amount caused by the influence of gravity (especially saddle-like deformation component which generates astigmatism) is substantially small as compared with the state of the conventional technique (i.e., state B) in which the crystal axis [111] of the fluorite lens 23 is disposed such that it coincides with the second optical axis AX2 and its crystal axis [100] is disposed along the reference plane. In other words, it can be found that in this embodiment, the astigmatism and thus wavefront aberration are less prone to be generated due to the saddle-like deformation of the optical surface of the fluorite lens 23 which is generated by the influence of gravity.

In the above-described embodiment, in order to minimize the astigmatism generated due to the saddle-like deformation of the optical surface of the fluorite lens 23 which is generated by the influence of gravity, the crystal axis [100] of the fluorite lens 23 is disposed such that it coincides with the second optical axis AX2 and its crystal axis [010] is disposed along the reference plane. However, the present invention is not limited to this. That is, only if the crystal axis [100] of the fluorite lens 23 (or a crystal axis which is equivalent to the crystal axis [100]) is disposed such that it coincides with the second optical axis AX2, the deformation amount caused by the influence of gravity becomes substantially smaller than that of the state of the conventional technique, even if the crystal axis [010] (or crystal axis which is equivalent to the crystal axis [010]) is not disposed along the reference plane, i.e., even if the angle formed by the crystal axis [010] (or crystal axis which is equivalent to the crystal axis [010]) with respect to the reference plane is not defined. This fact is apparent from the state H shown in FIGS. 4 and 5 in which the crystal axis [100] of the fluorite lens 23 is disposed such that it coincides with the second optical axis AX2 and its crystal axis [010] is disposed such that an angle of 135° is formed between the crystal axis [010] and the reference plane.

Further, only if the crystal axis [110] of the fluorite lens 23 (or a crystal axis which is equivalent to the crystal axis [110]) is disposed such that it coincides with the second optical axis AX2, the deformation amount caused by the influence of gravity becomes substantially smaller than that of the state of the conventional technique, even if the crystal axis [1-10] (or crystal axis which is equivalent to the crystal axis [1-10]) is not disposed along the reference plane. i.e., even if the angle formed by the crystal axis [1-10] (or crystal axis which is equivalent to the crystal axis [1-10]) with respect to the reference plane is not defined. However, in order to suppress, in the most excellent manner, the astigmatism generated due to the saddle-like deformation of the optical surface of the fluorite lens 23 generated by the influence of gravity, it is preferable to set the angle between the crystal axis [1-10] (or crystal axis which is equivalent to the crystal axis [1-10]) and the reference plane to 90°.

It is also apparent that the effect of the present invention can be obtained by disposing the crystal axis [111] (or crystal axis which is equivalent to the crystal axis [111]) of the fluorite lens 23 such that it coincides with the second optical axis AX2 and by setting the angle between its crystal axis [100] (or crystal axis which is equivalent to the crystal axis [100]) and the reference plane substantially greater than 0°. In this case, in order to suppress, in the most excellent manner, the astigmatism generated due to the saddle-like deformation of the optical surface of the fluorite lens 23 generated by the influence of gravity, it is preferable to set the angle between the crystal axis [100] (or crystal axis which is equivalent to the crystal axis [100]) and the reference plane to 60°.

In the embodiment, the present invention is applied to the fluorite lens disposed along the optical axis AX2 which is perpendicular to the direction of gravity, but the invention is not limited to this, and the invention can also be applied to a fluorite lens disposed along an optical axis which forms an acute angle of 60° or greater with respect to the direction of gravity.

Although the present invention is applied to the fluorite lens in this embodiment, the invention is not limited to this, and the invention can also be applied to an optical material made of other crystal material through which ultraviolet rays can pass such as other uniaxial crystal, such as barium fluoride crystal (BaF2), lithium fluoride crystal (LIF), sodium fluoride crystal (NaF), strontium fluoride crystal (SrF2) and beryllium fluoride crystal (BeF2).

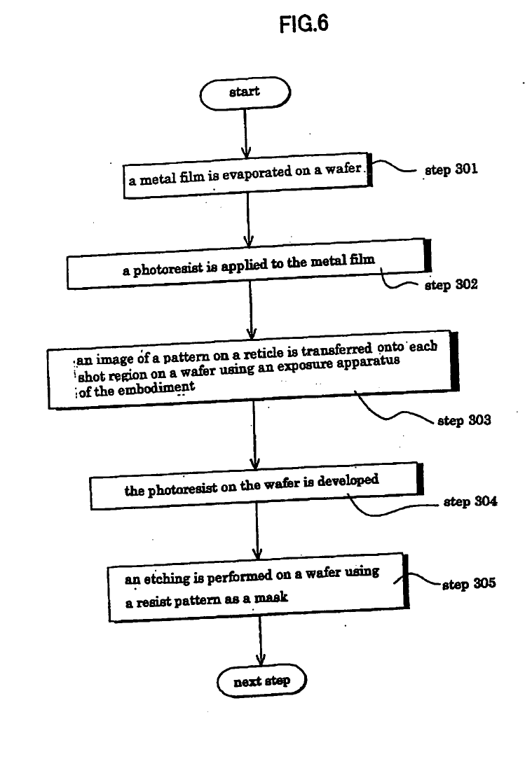

According to the exposure apparatus of the embodiment, it is possible to produce a micro device (a semiconductor device, an image pickup element, a liquid crystal display, a thin-film magnetic head) by illuminating a reticle (mask) using a luminaire (illumination step), and by exposing a transfer pattern formed on the mask onto a photosensitive substrate using the projection optical system (exposing step). A semiconductor device as the micro device can be obtained by forming a predetermined circuit pattern on a wafer or the like as the photosensitive substrate using the exposure apparatus of this embodiment. One example of the techniques for obtaining the semiconductor device will be explained with reference to a flowchart in FIG. 6.

First, in step 301 in FIG. 6, a metal film is evaporated on a lot of wafer. In next step 302, a photoresist is applied on the metal film on the lot of wafer. Then, in step 303, an image of a pattern on a mask is successively exposed and transferred on shot regions on the lot of wafer through a projection optical system using the exposure apparatus of the embodiment. In step 304, the photoresist on the lot of wafer is developed and then, in step 305, a resist pattern is etched as a mask on the lot of wafer, and a circuit pattern corresponding to the pattern on the mask is formed in the shot regions on the wafer.

Thereafter, a circuit pattern on an upper layer is formed, and a device such as a semiconductor device is produced. According to the above-described producing method of semiconductor device, a semiconductor device having extremely fine circuit pattern can be obtained with excellent throughput. The metal is evaporated on the wafer, a resist is applied on the metal film, and exposing, developing and etching steps are carried out in steps 301 to 305. Alternatively, it Is of course possible to form a silicon oxide film on the wafer and then, to apply a resist on the silicon oxide film prior to the above steps and then, exposing, developing and etching steps may be carried out.

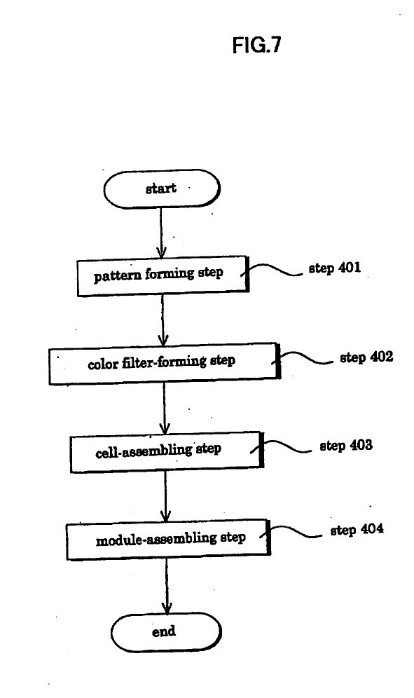

According to the exposure apparatus of the embodiment, it is possible to obtain a liquid crystal display as a micro device by forming a predetermined pattern (circuit pattern, electrode pattern or the like) on a plate (glass substrate). One example of such a technique will be explained with reference to a flowchart shown in FIG. 7. In pattern forming step 401 shown in FIG. 7, a pattern on a mask is transferred and exposed on a photosensitive substrate (glass substrate on which a resist is applied) using the exposure apparatus of the embodiment. This procedure is so-called photolithography step. By this photolithography step, a predetermined pattern including a large number of electrodes is formed on the photosensitive substrate. Then, the exposed substrate is subjected to developing, etching and resist-peeling off steps, a predetermined pattern is formed on the substrate, and the procedure is proceeded to next color filter-forming step 402.

Next, a color filter Is formed in color filter-forming step 402. In the color filter, a large number of sets each comprising three dots corresponding to R (Red), G (Green) and B (Blue) are arranged with a matrix, or a plurality of filter sets each comprising three (R, G, B) stripes are arranged in a direction of horizontal scanning line. After the color filter-forming step 402, cell-assembling step 403 is carried out. In cell-assembling step 403, a liquid crystal panel (liquid crystal cell) is assembled using the substrate having the predetermined pattern obtained in pattern forming step 401 and the color filter obtained in color filter-forming step 402. In cell-assembling step 403, liquid crystal is charged in between the substrate having the predetermined pattern obtained in pattern forming step 401 and the color filter obtained in color filter-forming step 402, and the liquid crystal panel (liquid crystal cell) is produced.

Thereafter, in module-assembling step 404, parts such as an electric circuit, a backlight for allowing the assembled liquid crystal panel (liquid crystal cell) to display are mounted to complete a liquid crystal display. According to the producing method of the liquid crystal display, a liquid crystal display having extremely fine circuit pattern can be obtained with excellent throughput.

Although the present invention is applied to a projection optical system of an exposure apparatus in the above embodiment, the invention is not limited to this, and the invention can also be applied to a general optical system including an illumination optical system of an exposure apparatus.

As explained above, according to the present invention, it is possible to suppress the deterioration in wavefront aberration caused by fine deformation of an optical surface and to realize an optical system having excellent optical performance by taking, into account, the arrangement of a crystal axis of a fluorite optical member disposed along an optical axis forming a predetermined angle with respect to a direction of gravity with respect to the optical axis.

The entire contents of PCT International Application No. PCT/JP02/08543 which has an International filing date of Aug. 23, 2002 which designates the United States of America are hereby incorporated by reference.

Although various exemplary embodiments have been shown and described, the invention is not limited to the embodiments shown. Therefore, the scope of the invention is intended to be limited solely by the scope of the claims that follow.

What is claimed is:

1. An optical system, comprising an optical member which is made of a crystal belonging to a cubic system and which is disposed along an optical axis which forms a predetermined angle between the optical axis and a direction of gravity, wherein
said optical member is disposed such that a crystal axis [100] (or a crystal axis which is equivalent to the crystal axis [100]) of said crystal substantially coincides with said optical axis.

2. An optical system as recited in claim 1, wherein
a crystal axis [010] (or a crystal axis which is equivalent to the crystal axis [010]) of said crystal is disposed along a plane including said direction of gravity and said optical axis or along a plane in the vicinity of said plane.

3. An optical system as recited in claim 1, wherein
a crystal axis [010] (or a crystal axis which is equivalent to the crystal axis [010]) of said crystal to disposed such that the crystal axis forms an arbitrary angle with respect to a plane including said direction of gravity and said optical axis.

4. An optical system, comprising an optical member which is made of a crystal belonging to a cubic system and which is disposed along an optical axis which forms a predetermined angle between the optical axis and a direction of gravity, wherein
said optical member is disposed such that a crystal axis [110] (or a crystal axis which is equivalent to the crystal axis [110]) of said crystal substantially coincides with said optical axis.

5. An optical system as recited in claim 4, wherein
a crystal axis [1-10] (or a crystal axis which is equivalent to the crystal axis [1-10]) of said crystal is disposed such that the crystal axis forms an arbitrary angle with respect to a plane including said direction of gravity and said optical axis.

6. An optical system as recited in claim 5, wherein said arbitrary angle is about 90°.

7. An optical system, comprising an optical member which is made of a crystal belonging to a cubic system and which is disposed along an optical axis which forms a predetermined angle between the optical axis and a direction of gravity, wherein
said optical member is disposed such that a crystal axis [111] (or a crystal axis which is equivalent to the crystal axis [111]) of said crystal substantially coincides with said optical axis, and
a crystal axis [100] (or a crystal axis which is equivalent to the crystal axis [100]) of said crystal is set to form an angle which is substantially greater than 0° with respect to a plane including said direction of gravity and said optical axis.

8. An optical system as recited in claim 7, wherein
a crystal axis [100] (or a crystal axis which is equivalent to the crystal axis [100]) of said crystal is disposed such that the crystal axis forms an arbitrary angle with respect to a plane including said direction of gravity and said optical axis.

9. An optical system as recited in claim 8, wherein said arbitrary angle is about 30° or about 60°.

10. An optical system as recited in claim 1, further comprising an optical member disposed along an optical axis in said direction of gravity, wherein
said predetermined angle is in a range of 60° to 90°.

11. An optical system as recited in claim 1, wherein
said crystal is a calcium fluoride crystal or a barium fluoride crystal.

12. An exposure apparatus, comprising:
an illumination optical system which illuminates a mask; and
said optical system as recited in claim 1 which forms an image of a pattern formed on said mask onto a photosensitive substrate.

13. An exposure apparatus, comprising:
said optical system as recited in claim 1 which illuminates a mask; and
an optical system which forms an image of a pattern formed on said mask onto a photosensitive substrate.

14. A device producing method, comprising:
exposing a device pattern of said mask onto said photosensitive substrate using said exposure apparatus as recited in claim 12; and
developing said photosensitive substrate.

15. A device producing method, comprising:
exposing a device pattern of said mask onto said photosensitive substrate using said exposure apparatus as recited in claim 13; and
developing said photosensitive substrate.
